(19) United States
(12) Patent Application Publication
(10) Pub. No.: US 2026/0103138 A1
(43) Pub. Date: Apr. 16, 2026

(54) TOWABLE AIR CART

(71) Applicant: Ausplow Pty. Ltd., Cockburn Central (AU)

(72) Inventors: Brett Forbes LOVELL, Perth (AU); Richard Alec WOODE, Perth (AU); John William RYAN, Perth (AU)

(21) Appl. No.: 19/318,523

(22) Filed: Sep. 4, 2025

(30) Foreign Application Priority Data
Sep. 6, 2024 (AU) 2024902819

(51) Int. Cl. B60P 3/22; A01C 15/00; B60P 7/08

(52) U.S. Cl. CPC B60P 3/2215; A01C 15/003; A01C 15/005; B60P 3/221; B60P 7/0823

(57) ABSTRACT

A towable cart (100, 200) for storing granular and/or liquid product, the towable cart (100, 200) including a chassis (300) configured for attachment to a prime mover, the chassis (300) including a plurality of mounting points (310) that provide releasable and reconfigurable attachment of a plurality of product tanks (400).

### CROSS REFERECE OF RELATED APPLICATION

The present application claims priority to Australian Patent Application No. 2024902819 filed on Sep. 6, 2024, which is incorporated herein by reference in its entirety.

### FIELD

The present invention relates to air carts. In particular, the invention relates to modular air carts that are towable and may be referred to as a towable fertilising cart.

The invention has been developed primarily for use in the agricultural industry and will be described hereinafter with reference to these applications. However, it will be appreciated that the invention is not limited to this particular field of use.

### BACKGROUND

Presently, air carts are used to store and deliver granular and/or liquid product to facilitate and promote growth of crops as well for placement of seed. These air carts are usually custom built to meet an operator's specific requirements. An operator may request that the air cart be of a tow-between configuration or a tow-behind configuration. The operator may also request certain features in specific locations.

For example, an operator may request the cart to be manufactured as a tow-behind cart with several medium sized storage tanks that has an auger on the left side and stairs to access the tops of storage tanks on the right side. Another operator may request the same cart to be manufactured as a tow-between cart with the auger and stairs on opposite sides. Presently, no manufacturers offer such a level of flexibility in the configuration of the cart.

In the above example, each request needs to be redesigned and reengineered meaning that more time and cost is associated with manufacturing fertilising carts. Major changes are not feasible due to the need for reengineering the carts and the costs associated with doing so. Accordingly, what is needed is a cart that is easily customisable and easy to manufacture.

### SUMMARY

It is an object of the present invention to substantially overcome, or at least ameliorate, one or more of the disadvantages of existing arrangements, or at least provide a useful alternative to existing arrangements.

There is disclosed herein a towable cart for storing granular and/or liquid product, the towable cart including:

a chassis configured for attachment to a prime mover, the chassis including a plurality of mounting points that provide releasable and reconfigurable attachment of a plurality of product tanks.

In one embodiment, the cart is towable in a towing direction, and wherein the chassis includes a first pair of longitudinal beams and a second pair of longitudinal beams, each of the first pair of beams and the second pair of beams include the plurality of mounting points.

In one embodiment, the chassis includes a plurality of sub-members to connect the first pair of beams and the second pair of beams to each other.

In one embodiment, the plurality of sub-members, the first pair of beams and the second pair of beams form a truss.

In one embodiment, the plurality of product tanks are mounted to the first pair of beams.

In one embodiment, each of the plurality of product tanks include a support structure, the support structure being configured to mount to the first pair of beams.

In one embodiment, the support structure includes: a frame for the product tank to sit thereon; and one or more straps to hold the product tank to the frame.

In one embodiment, the plurality of product tanks are different in volumetric capacity such that an overall volumetric capacity of the plurality of tanks mounted to the chassis is changeable.

In one embodiment, the plurality of product tanks includes at least two product tanks selected from:

a first tank of a first volumetric capacity; and

a second tank of a second volumetric capacity, the second tank having a volumetric capacity greater than that of the first tank; and/or

a third tank of a third volumetric capacity, the third tank having a volumetric capacity greater than that of the second tank.

In one embodiment, the plurality of mounting points allow attachment of one or more farming accessories to one or both of the first pair of beams and to one or both of the second pair of beams.

In one embodiment, the first pair of beams and the second pair of beams each include a first end opposite a second end, the plurality of mounting points being located between the first end and the second end.

In one embodiment, there is a first portion of mounting points toward the first end for attaching the one or more farming accessories.

In one embodiment, there is a second portion of mounting points toward the second end for attaching the one or more farming accessories.

In one embodiment, one of the plurality of farming accessories is a ladder connected to a catwalk, the ladder and catwalk being connected to the first pair of beams at least at the first portion and the second portion of mounting points.

In one embodiment, one of the plurality of farming accessories is an auger connected to at least the second portion of mounting points.

In one embodiment, one of the plurality of farming accessories is a toolbox connected to the one of the first pair of beams and one of the second pair of beams at the first portion of mounting points.

In one embodiment, one of the plurality of farming accessories is a hand wash station connected to one of the first pair of beams and one of the second pair of beams at the first portion of mounting points.

In one embodiment, one of the plurality of farming accessories is a liquid cabinet connected to one of the first pair of beams and one of the second pair of beams at the first portion of mounting points.

In one embodiment, one of the plurality of farming accessories is a container of trace elements connected to one of the first pair of beams and one of the second pair of beams at the first portion of mounting points.

In one embodiment, the plurality of product tanks and farming accessories are connected to the chassis mounting points by one or more fasteners.

In one embodiment, the chassis includes at least one front connection point at the first end, the front connection point configured for connecting to a front hitch.

In one embodiment, the chassis includes at least one rear connection point at the second end, the rear connection point configured for connecting to a rear subframe.

In one embodiment, the cart is reconfigurable between:

a tow-between configuration in which the cart comprises an axle, the front hitch and a rear hitch connected to the rear connection point; and

a tow-behind configuration in which the cart comprises two axles, the front hitch and the rear subframe.

There is also disclosed herein a method of manufacturing a towable cart, wherein the method comprises the steps of:

providing a chassis including a plurality of mounting points, the chassis being suitable for accepting two or more wheels; and

mounting a plurality of product tanks to any one of the plurality of mounting points such that the plurality of mounting points provide releasable and reconfigurable attachment of the plurality of product tanks.

In one embodiment, the method further comprises the step of mounting a rear hitch to the chassis.

In one embodiment, the method further comprises the step of:

following use of the towable fertilizing cart, reconfiguring the plurality of product tanks mounted to the chassis to alter the number of product tanks mounted to the chassis or the size of the product tanks mounted to the chassis.

In one embodiment, the method further comprises the step of reconfiguring the plurality of product tanks to divide a total volumetric capacity of the plurality of product tanks differently across the plurality of product tanks.

There is also disclosed herein a reconfigurable cart for storing granular and/or liquid product in one or more product tanks, the reconfigurable cart including:

a chassis, the chassis including a plurality of mounting points to provide releasable and reconfigurable attachment of the one or more product tanks.

### BRIEF DESCRIPTION OF THE DRAWINGS

For a more complete understanding of the present invention, exemplary embodiments of the invention are explained in more detail in the following description with reference to the accompanying drawing figures, in which like reference signs designate like parts and in which:

FIG. 1 shows a perspective view of a towable cart according to an embodiment in a tow-behind configuration.

FIG. 2 shows a perspective view of the towable cart shown in FIG. 1 in a tow-between configuration.

FIGS. 3A to 3D show perspective views of an embodiment of a chassis and chassis subframes for use with the cart shown in FIG. 1.

FIGS. 4A to 4D show perspective views of the chassis shown in FIG. 3A and chassis subframes for use with the cart shown in FIG. 2.

FIGS. 5A to 5C show an embodiment of a tank assembly for use with the cart shown in FIG. 1 and FIG. 2.

FIGS. 6A to 6C show an embodiment of a tank assembly for use with the cart shown in FIG. 1 and FIG. 2.

FIGS. 7A to 7C show an embodiment of a tank assembly for use with the cart shown in FIG. 1 and FIG. 2

FIGS. 8A to 8C show an embodiment of tank subframes of the tank assemblies shown in FIGS. 5A to 7C.

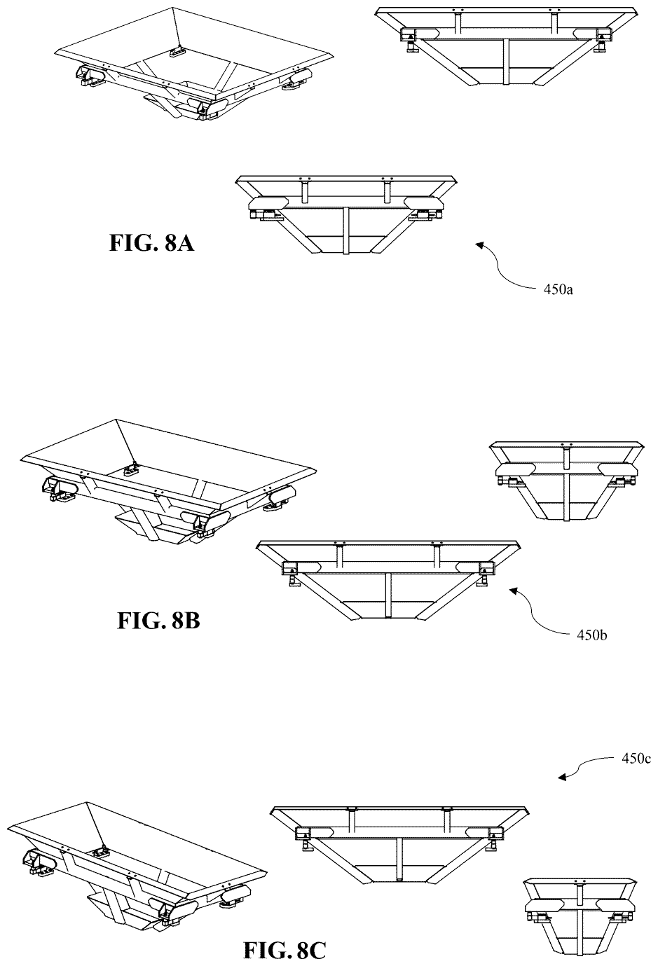

FIGS. 9A to 9E show several tank configurations used with the cart shown in FIG. 1.

FIGS. 10A to 10E show several tank configurations used with the cart shown in FIG. 2.

FIG. 11 shows a perspective view of the cart shown in FIG. 2 as well as a detailed view (Detail A) of the chassis.

FIG. 12 shows a perspective view of the cart shown in FIG. 2 as well as enlarged views showing an embodiment of various farming accessories.

FIG. 13 shows steps of a method of manufacturing a cart.

Common reference numerals are used throughout the figures to indicate similar features.

### DETAILED DESCRIPTION

The present disclosure provides a modular towable cart system that addresses the limitations of conventional air carts by offering unprecedented flexibility in configuration and customisation. The system features a chassis with strategically positioned mounting points that enable the releasable and reconfigurable attachment of various components, including product tanks of different sizes and farming accessories. This modular approach allows manufacturers to produce a standardised chassis platform that may be readily adapted to meet diverse operator requirements without the need for extensive redesign or reengineering. The system may be configured in either tow-between or tow-behind arrangements, and components may be repositioned or replaced as operational needs change, providing operators with a cost-effective solution that can evolve with their farming operations.

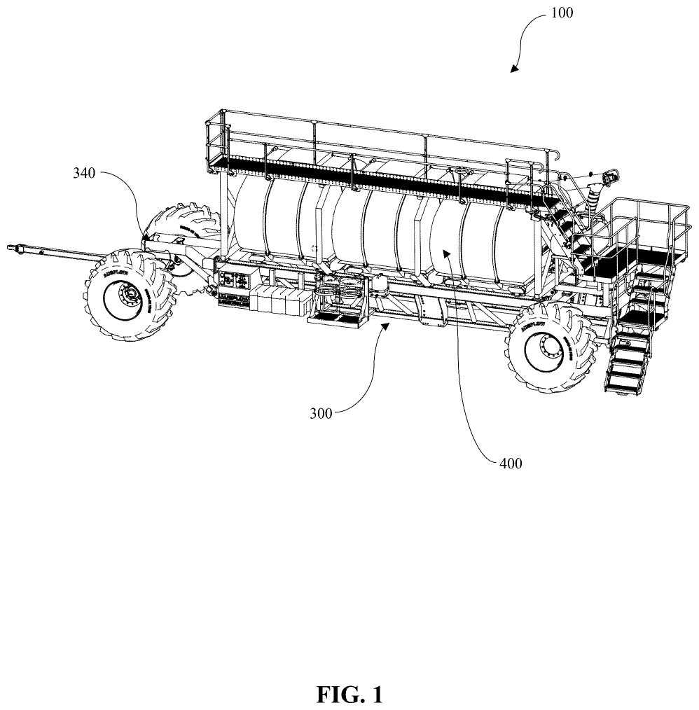

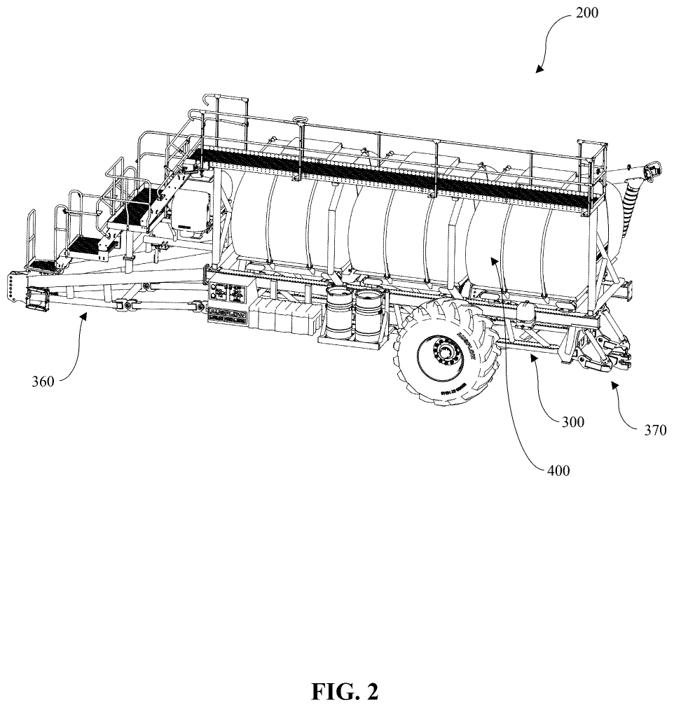

FIG. 1 shows a towable cart 100 according to an embodiment. The cart 100 is used for storing granular and/or liquid product such as fertiliser and seed. The cart 100 is shown in a tow-behind configuration and can be manufactured or converted to a tow-between configuration as shown in FIG. 2 and numbered 200. The carts 100, 200 are modular and include similar components such that they are reconfigurable to suit an operator's requirements. The modular design may enable rapid field conversion between configurations without specialised equipment, typically requiring only standard wrenches and fasteners. More typically however, the module design may allow for customers to more easily customise their orders at the build stage.

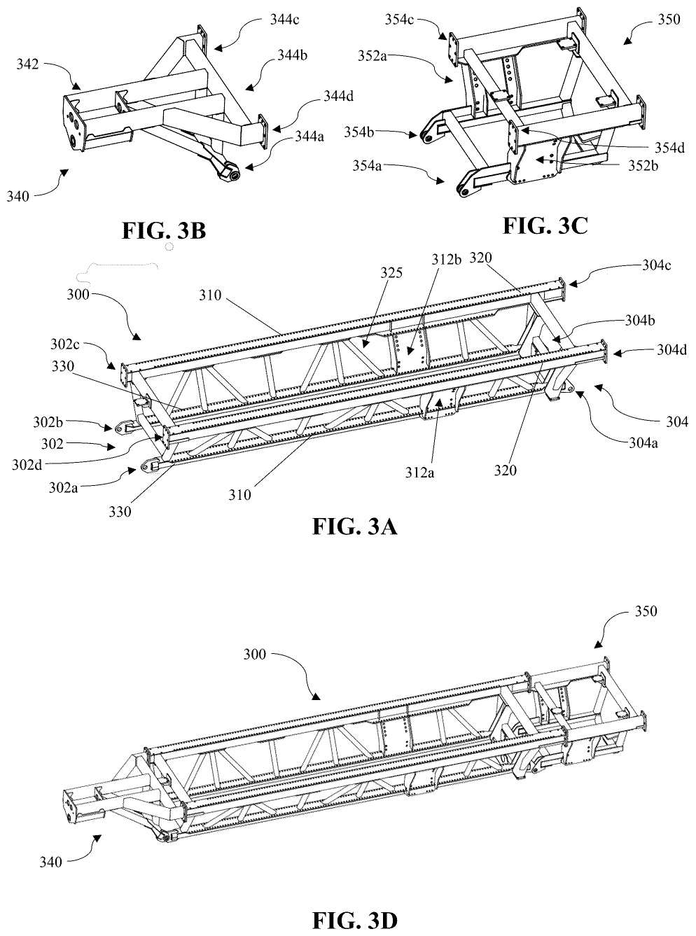

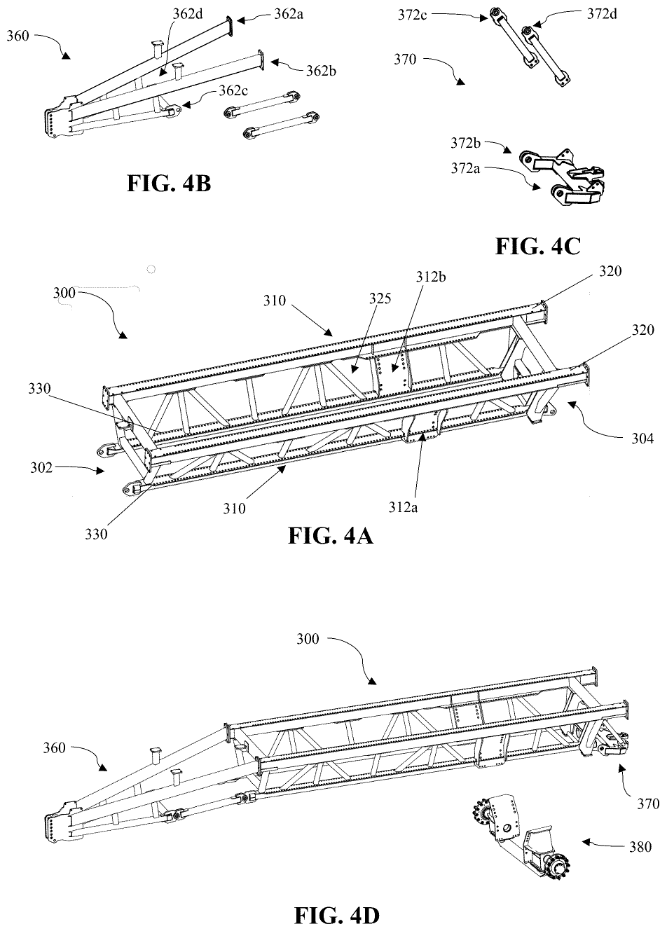

The towable cart 100, 200 includes a chassis 300 that is configured for attachment to a prime mover (not shown), such as, for example, a tractor. The chassis 300 is shown in detail in FIGS. 3A and 4A. The chassis 300 includes a plurality of mounting points 310 that provide releasable and reconfigurable attachment of a plurality of product tanks 400. In the embodiment shown, the plurality of mounting points 310 are in the form of a plurality of mounting holes that are tapped to accept a fastener, such as high-tensile bolts, for example. However, it is envisaged that instead of mounting holes, mounting protrusions may be used. In another embodiment (not shown), the mounting protrusions may be shaped to securely engage a complementary shaped slot or recess, to enable quicker release of the product tanks 400 or other item attached to the chassis 300.

The chassis 300 includes a first pair of longitudinal beams 320 and a second pair of longitudinal beams 330. The first pair of longitudinal beams 320 and the second pair of longitudinal beams 330 include the plurality of mounting points 310 positioned along their length. The first pair of beams 320 and the second pair of beams 330 are connected to each other via a plurality of sub-members 325 to form a truss-like structure.

For the tow-behind configuration, as shown in FIGS. 3A to 3D, the chassis 300 may include additional substructures. These additional substructures may include a front hitch 340 and a rear subframe 350. The front hitch 340 may be connected to a front end 302 of the chassis 300 and provide connection to a prime mover. The rear subframe 350 may be connected to a rear end 304 of the chassis 300. The front hitch 340 and the rear subframe 350 allows for the provision of a front and rear axle. More specifically, the front hitch 340 may be connected to the front axle via a front axle mounting point 342. Similarly, the rear subframe 350 may include a rear axle mounting point 352a, 352b for connection to the rear axle. The front hitch 340 and the rear subframe 350 may include connection points 344a, 344b, 344c, 344d and 354a, 354b, 354c, 354d to connect the front hitch 340 and the rear subframe 350 to the chassis 300 via corresponding or complementary connection points 302a, 302b, 302c, 302d and 304a, 304b, 304c, 304d. Each connection point may be in the form of a flange, or an eyelet as shown. Alternately, it is envisaged that other types of connections may be used.

For the tow-between configuration, as shown in FIGS. 4A to 4D, the chassis 300 may include different sub-structures. These substructures may include a front hitch 360 and a rear hitch 370. The front hitch 360 may be connected to a front end 302 of the chassis 300 and provide connection to a prime mover. The rear hitch 370 may be connected to a rear end 304 of the chassis 300. The front hitch 360 may be connected to the chassis 300 via connection points 362a, 362b, 362c, 362d on the front hitch 360 and the corresponding or complementary connection points 302a, 302b, 302c, 302d (not number in FIG. 4A). The rear hitch 370 may be connected to the connection points 304a, 304b, 304c, 304d via corresponding or complementary connection points 372a, 372b, 372c, 372d. In the tow-between configuration, an axle mounting point 312a, 312b that is part of the chassis 300 may be used. The axle mounting point 312a, 312b is provided toward the middle of the chassis 300, in between the front end 302 and the rear end 304 and is configured to accept an axle 380. Each connection point may be in the form of a flange, or an eyelet as shown. Alternately, it is envisaged that other types of connections may be used. Moreover, the same chassis 300 may be used for either the tow between configuration or the tow behind configuration.

The plurality of product tanks 400 are mountable to the chassis 300 in a reconfigurable manner. More specifically, the product tanks 400 may each include a tank support structure 450 to mount the tanks 400 to the first pair of beams 320. The tank support structure 450 may be configured to nest within the chassis 300 such that at least a portion of the tank support structure 450 is located between and/or below the first pair of longitudinal beams 320. One or more load cells may be positioned between the tanks 400 and the first pair of beams 320 to monitor the weight of the product tanks 400 when mounted to the chassis 300.

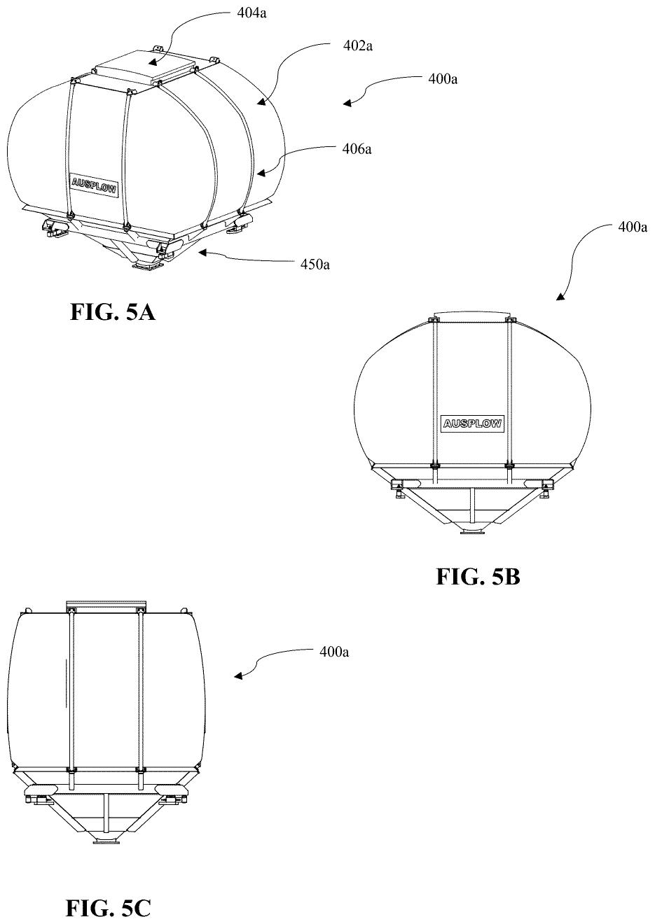

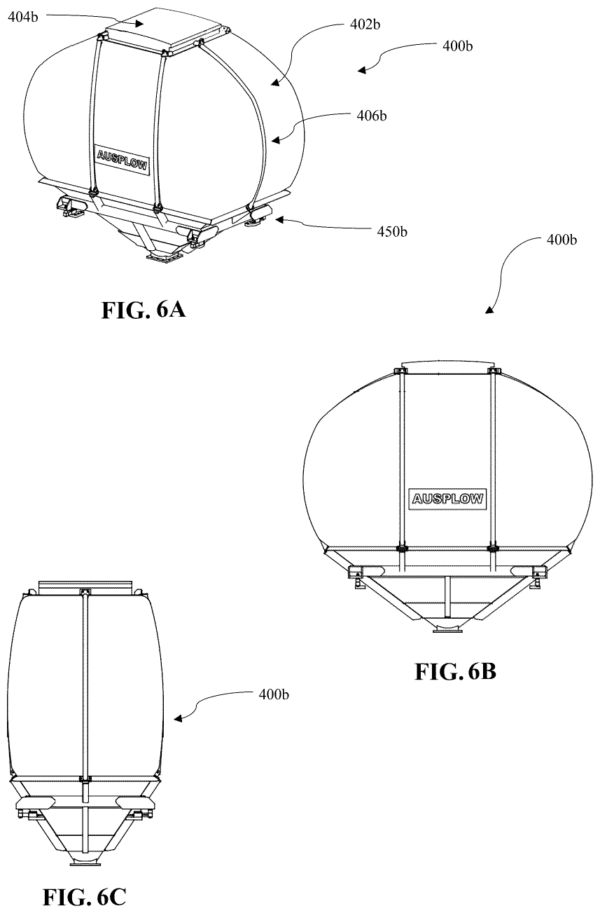

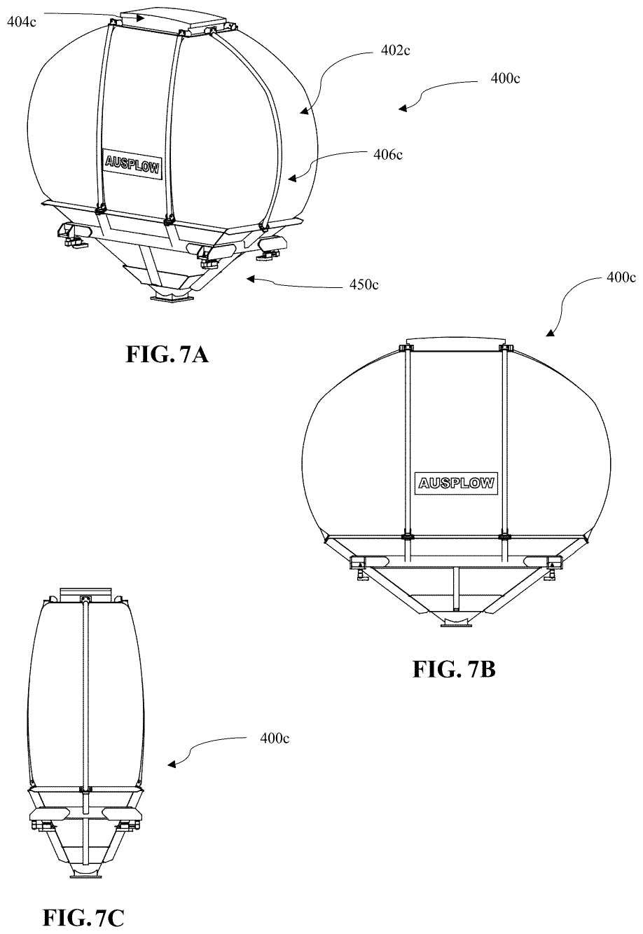

In the embodiment shown, the plurality of product tanks 400 may be of different sizes or different capacities, each of which are numbered 400a, 400b and 400c. The tanks 400 may include at least one sidewall 402a, 402b, 402c that defines a cavity. The plurality of product tanks 400 may include a lid 404a, 404b, 404c covering an opening leading to the cavity. The plurality of product tanks 400 may include one or more straps 406a, 406b, 406c to secure the tank to the tank support structure 450a, 450b, 450c. In FIGS. 5A to 5C, a large tank 400a is shown. The tank 400a may have a capacity of about 9000 litres or more. In FIGS. 6A to 6C, a medium tank 400b is shown. The tank 400b may have a capacity of about 6000 litres. In FIGS. 7A to 7C, small tank 400c is shown. The tank 400c may have a capacity of about 4000 litres or less. It may be said that the plurality of product tanks 400 may be equal in volumetric capacity and/or different in volumetric capacity such that an overall volumetric capacity of the plurality of tanks 400 mounted to the chassis 300 is changeable. Thus, the plurality of product tanks 400 mounted to the chassis 300 may be said to include at least two product tanks 400 selected from: the tank 400c of a first volumetric capacity; and/or the tank 400b of a second volumetric capacity, the tank 400b having a volumetric capacity greater than that of the tank 400c; and/or the tank 400a of a third volumetric capacity, the tank 400a having a volumetric capacity greater than that of the tank 400b.

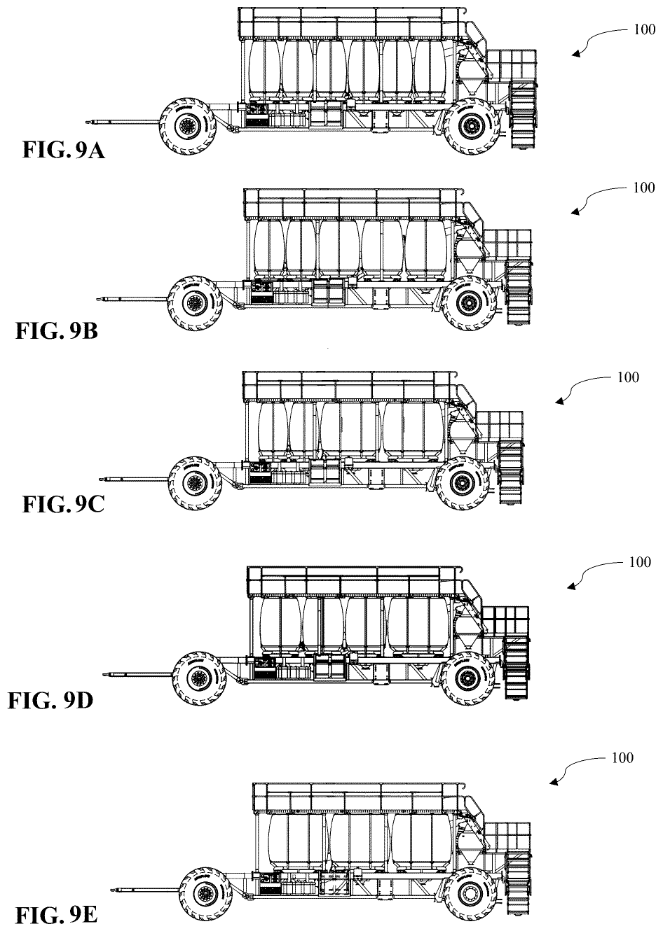

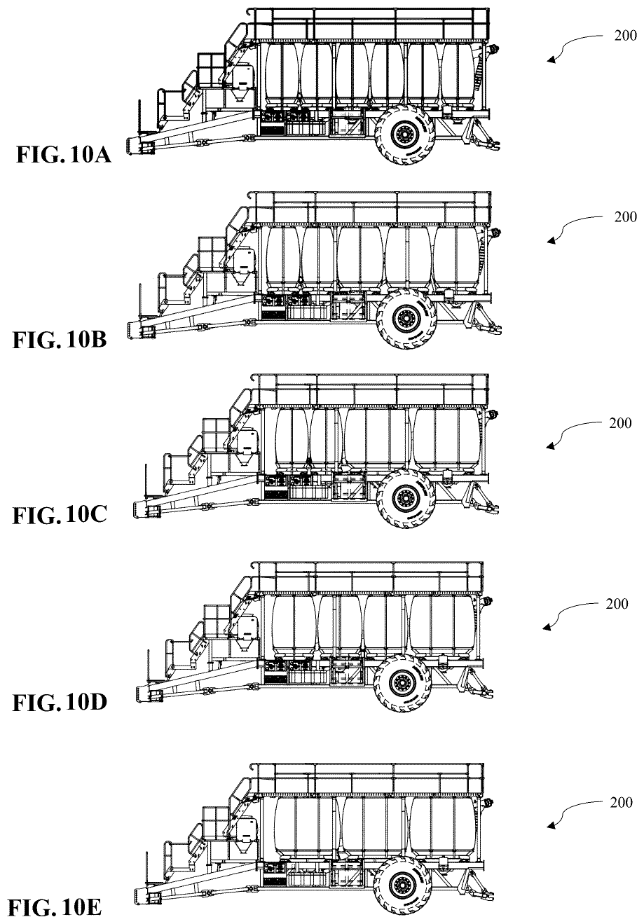

As the chassis 300 includes a plurality of mounting points 310, the chassis 300 may accept various combinations of tanks 400a to 400c. For example, as shown in FIGS. 9A and 10A, 6 tanks 400c are mounted to the chassis 300. In FIGS. 9B and 10B, 2 tanks 400c and 3 tanks 400b are mounted to the chassis 300. In FIGS. 9C and 10C, 2 tanks 400c and 2 tanks 400a are mounted to the chassis 300. In FIGS. 9D and 10D, 3 tanks 400b and 1 tank 400a are mounted to the chassis 300. In FIGS. 9E and 10E, 3 tanks 400a are mounted to the chassis 300. As shown in FIGS. 9A to 9E and 10A to 10E, the chassis 300 is modular in its ability to accept a plurality of tanks of the same or different sizes/volumetric capacities. As the chassis 300 can accept a plurality of tanks of different sizes, the total capacity can be split in different ways to hold different amounts of various products, depending on the operator's requirements. For example, some operators may require two-thirds (⅔) slow release and one-third (⅓) fast release fertiliser for their particular soil types, whilst other operators may require half (½) slow release and half (½) fast release fertiliser.

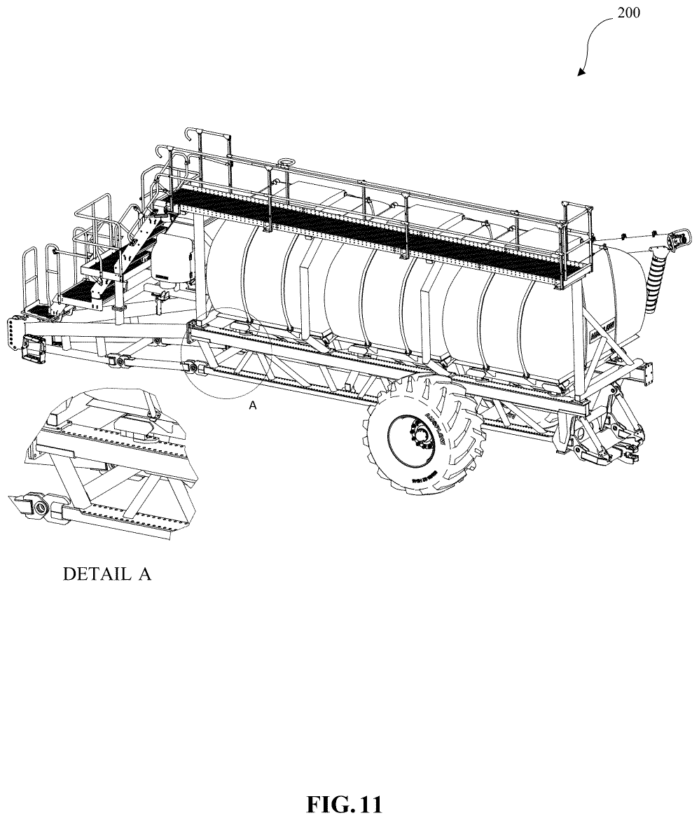

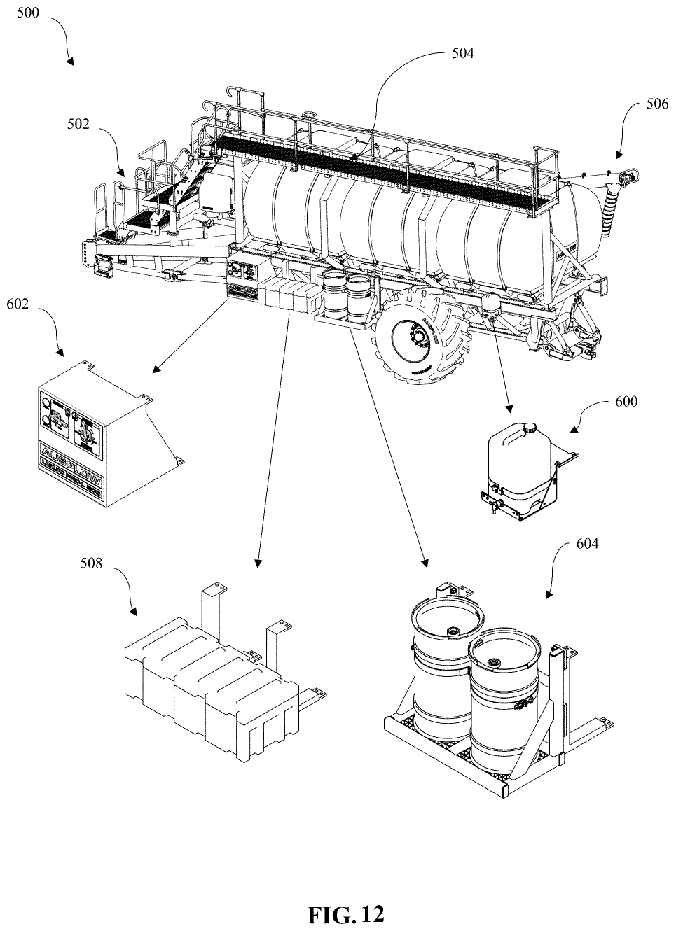

The plurality of mounting points 310, shown in detail in FIG. 11 (Detail A view) also allow attachment of one or more farming accessories or tools 500. Exemplary embodiments of farming accessories/tools 500 are shown in detail in FIG. 12. The farming accessories 500 may include a ladder 502 that may lead up to a catwalk 504 above the plurality of tanks 400. The farming accessories 500 may further include an auger 506 for delivering granular product up and into one or more of the plurality of product storage tanks 400. The farming accessories 500 may further include a toolbox 508, a handwash station 600, a liquid cabinet 602 and/or a container for storing trace elements 604 or the like.

The farming accessories or tools 500 may include a frame or attachment point to allow the accessory or tool 500 to be connected to the plurality of the mounting points 310 on the chassis 300. When mounting farming accessories or tools 500 to one side of the towable cart 100, 200, the accessories or tools 500 may be connected to one of the first pair of longitudinal beams 320 or to both the first pair 320 and the second pair of longitudinal beams 330 such that a connection is formed between the accessory or tool 500 and the upper and lower beam. In this way, a sturdy and stable connection can be formed. Additionally, the position of accessory or tool 500 along the chassis 300 can be adjusted depending on the user's requirements.

For example, a first portion of the mounting points 310 are located toward the front end 302 of the chassis 300 and a second portion of the mounting points 310 are located toward the rear end 304 of the chassis 300. The ladder 502 and catwalk 504 may be connected to the first pair of beams 320 at the first portion and the second portion of mounting points 310. The auger 506 may be connected to the first pair of beams 320 at the second portion of mounting points 310. The tool box 508 may be connected to one of the first pair of beams 320 and the second pair of beams 330 at the first portion of mounting points 310. The hand wash station 600, the liquid cabinet 602 and the container for storing trace elements 604 may be connected to one of the first pair of beams and one of the second pair of beams at the first portion of mounting points 310. Whilst these farming accessories 500 have been described with reference to the embodiments shown, it is envisaged that the farming accessories 500 may be mounted in different positions along the pairs of beams, on either side of the chassis 300 due to the plurality of mounting points 310 and modular design of the towable cart 100, 200.

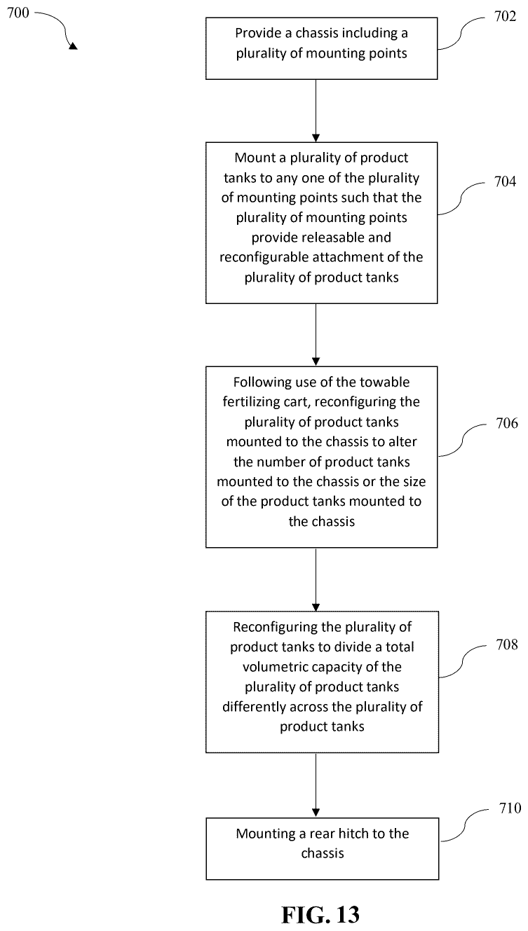

Also disclosed herein is a method 700 of manufacturing a towable cart 100, 200 as shown in FIG. 13. The method 700 comprises the step 702 of providing a chassis 300 including a plurality of mounting points 310, the chassis 300 being suitable for accepting two or more wheels. The method 700 also comprises the step 704 of mounting a plurality of product tanks 400 to any one of the plurality of mounting points 310 such that the plurality of mounting points 310 provide releasable and reconfigurable attachment of the plurality of product tanks 400.

The method 700 may further comprise the step 706 of, following use of the towable fertilizing cart, reconfiguring the plurality of product tanks 400 mounted to the chassis 300 to alter the number of product tanks 400 mounted to the chassis 300 or the size of the product tanks 400 mounted to the chassis 300.

The method 700 may further comprise the step 708 of reconfiguring the plurality of product tanks 400 to divide a total volumetric capacity of the plurality of product tanks 400 differently across the plurality of product tanks 400. As described above some operators may require more fast release fertiliser than slow release fertiliser and other operators may require the opposite amount or equal amounts of fertiliser.

The method 700 may further comprise the step 710 of mounting a rear hitch 370 to the chassis 300.

Various forms of the towable cart 100, 200 described above may have one or more of the following advantages.

The cart is modular by virtue of the plurality of mounting points 310 and can be reconfigured to hold product tanks of different sizes in different positions along the beams.

The chassis 300 is reconfigurable to tow-between or tow-behind configurations by virtue of the connection points at the front and rear of the chassis 300.

The reconfiguration of the cart may be performed during and after the manufacture of the cart.

Although specific embodiments of the invention are illustrated and described herein, it will be appreciated by those of ordinary skill in the art that a variety of alternative and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, etc. are used merely as labels, and are not intended to impose numerical requirements on or to establish a certain ranking of importance of their objects.

1. A towable cart for storing granular and/or liquid product, the towable cart including:
a chassis configured for attachment to a prime mover, the chassis including a plurality of mounting points that provide releasable and reconfigurable attachment of a plurality of product tanks.

2. The towable cart of claim 1, wherein the cart is towable in a towing direction, and wherein the chassis includes a first pair of longitudinal beams and a second pair of longitudinal beams, each of the first pair of beams and the second pair of beams include the plurality of mounting points.

3. The towable cart of claim 2, wherein the chassis includes a plurality of sub-members to connect the first pair of beams and the second pair of beams to each other, the plurality of sub-members, the first pair of beams and the second pair of beams forming a truss.

4. The towable cart of claim 3, wherein the plurality of product tanks are mounted to the first pair of beams.

5. The towable cart of claim 4, wherein each of the plurality of product tanks include a support structure, the support structure including: a frame for the product tank to sit thereon; and one or more straps to hold the product tank to the frame, the support structure being configured to mount to the first pair of beams.

6. The towable cart of claim 1, wherein the plurality of product tanks are different in volumetric capacity such that an overall volumetric capacity of the plurality of tanks mounted to the chassis is changeable.

7. The towable cart of claim 6, wherein the plurality of product tanks includes at least two product tanks selected from:
a first tank of a first volumetric capacity; and
a second tank of a second volumetric capacity, the second tank having a volumetric capacity greater than that of the first tank; and/or
a third tank of a third volumetric capacity, the third tank having a volumetric capacity greater than that of the second tank.

8. The towable cart of claim 3, wherein the plurality of mounting points allow attachment of one or more farming accessories to one or both of the first pair of beams and to one or both of the second pair of beams.

9. The towable cart of claim 8, wherein the first pair of beams and the second pair of beams each include a first end opposite a second end, the plurality of mounting points being located between the first end and the second end.

10. The towable cart of claim 9, wherein there is a first portion of mounting points toward the first end for attaching at least one of the one or more farming accessories; and a second portion of mounting points toward the second end for attaching at least one of the one or more farming accessories.

11. The towable cart of claim 10, wherein one of the one or more farming accessories is a ladder connected to a catwalk, the ladder and catwalk being connected to the first pair of beams at least at the first portion and the second portion of mounting points.

12. The towable cart of claim 10, wherein one or more farming accessories is one or more selected from:
an auger connected to at least the second portion of mounting points; and
a toolbox connected to the one of the first pair of beams and one of the second pair of beams at the first portion of mounting points; and
a container of trace elements connected to one of the first pair of beams and one of the second pair of beams at the first portion of mounting points; and
a hand wash station connected to one of the first pair of beams and one of the second pair of beams at the first portion of mounting points; and
a liquid cabinet connected to one of the first pair of beams and one of the second pair of beams at the first portion of mounting points.

13. The towable cart of claim 9, wherein the chassis includes at least one front connection point at the first end, the front connection point configured for connecting to a front hitch.

14. The towable cart of claim 13, wherein the chassis includes at least one rear connection point at the second end, the rear connection point configured for connecting to a rear subframe.

15. The towable cart of claim 14, wherein the cart is reconfigurable between:
a tow-between configuration in which the cart comprises an axle, the front hitch and a rear hitch connected to the rear connection point; and
a tow-behind configuration in which the cart comprises two axles, the front hitch and the rear subframe.

16. A method of manufacturing a towable cart, wherein the method comprises the steps of:
providing a chassis including a plurality of mounting points, the chassis being suitable for accepting two or more wheels; and
mounting a plurality of product tanks to any one of the plurality of mounting points such that the plurality of mounting points provide releasable and reconfigurable attachment of the plurality of product tanks.

17. The method of claim 16, wherein the method further comprises the step of mounting a rear hitch to the chassis.

18. The method of claim 17, wherein the method further comprises the step of:
following use of the towable fertilizing cart, reconfiguring the plurality of product tanks mounted to the chassis to alter the number of product tanks mounted to the chassis or the size of the product tanks mounted to the chassis.

19. The method of claim 18, wherein the method further comprises the step of reconfiguring the plurality of product tanks to divide a total volumetric capacity of the plurality of product tanks differently across the plurality of product tanks.

20. A reconfigurable cart for storing granular and/or liquid product in one or more product tanks, the reconfigurable cart including:
a chassis, the chassis including a plurality of mounting points to provide releasable and reconfigurable attachment of the one or more product tanks.
